(19) United States
(12) Patent Application Publication
(10) Pub. No.: US 2005/0049327 A1
(43) Pub. Date: Mar. 3, 2005

(54) Drag reducing agents for multiphase flow

(76) Inventors: Vladimir Jovancicevic, Richmond, TX (US); Steven Jeremy Weghorn, Missouri City, TX (US); Paul R. Hart, Sugar Land, TX (US)

Correspondence Address: MADAN, MOSSMAN & SRIRAM, P.C., 2603 AUGUSTA, SUITE 700, HOUSTON, TX, 77057, US

(21) Appl. No.: 10/927,613

(22) Filed: Aug. 26, 2004

Related U.S. Application Data
(60) Provisional application No. 60/499,460, filed on Sep. 2, 2003.

(51) Int. Cl. B05D 5/08

(52) U.S. Cl. 523/175

(57) ABSTRACT

A process for using high molecular weight, anionic, hydrophilic polymers without formation of deleterious emulsions to facilitate flow in multiphase pipelines containing both oil and water (e.g., oil/water, oil/water/gas, oil/water/solids, and oil/water/gas/solids) such as are used for oil or gas production, gathering, and transmission; hydrotransport of oilsand or heavy oil slurries is described. Specific examples of suitable drag reducing polymers include anionic, hydrophilic polyacrylamides having a molecular weight of greater than 1 megadalton.

### CROSS-REFERENCE TO RELATED APPLICATION

This application claims the benefit of U.S. provisional application No. 60/499,460 filed Sep. 2, 2003.

### FIELD OF THE INVENTION

The invention relates to agents to be added to fluids flowing through a conduit to reduce the drag therethrough, and most particularly relates, in one non-limiting embodiment, to polymeric drag reducing agents (DRAs) for liquids such as mixtures and emulsions of water and hydrocarbons, where the additives exhibit lower emulsion creating tendencies.

### BACKGROUND OF THE INVENTION

The use of polyalpha-olefins or copolymers thereof to reduce the drag of a hydrocarbon flowing through a conduit, and hence the energy requirements for such fluid hydrocarbon transportation, is well known. These drag reducing agents or DRAs have taken various forms, including slurries of ground polymer particulates and gels. A problem generally experienced with simply grinding the polyalpha-olefins (PAOs) is that the particles will “cold flow” or stick together after a relatively short time, thus making it impossible to place the PAO in the hydrocarbon in a form that will dissolve or otherwise mix with the hydrocarbon in an efficient manner. Further, the grinding process irreversibly degrades the polymer, thereby reducing the drag reduction efficiency of the polymer.

One common solution to preventing cold flow is to coat the ground polymer particles with an anti-agglomerating agent. Cryogenic grinding of the polymers to produce the particles prior to or simultaneously with coating with an anti-agglomerating agent has also been used. However, some powdered or particulate DRA slurries require special equipment for preparation, storage and injection into a conduit to ensure that the DRA is completely dissolved in the hydrocarbon stream.

Gel or solution DRAs have also been tried in the past. However, these drag reducing gels also demand specialized injection equipment, as well as pressurized delivery systems. They are also limited to about 10% polymer as a maximum concentration in a carrier fluid due to the high solution viscosity of these DRAs. Thus, transportation costs of the DRA are considerable, since up to about 90% of the volume being transported and handled is inert material.

Further, as noted, some polymeric DRAs additionally suffer from the problem that the high molecular weight polymer molecules can be irreversibly degraded (reduced in size and thus effectiveness) when subjected to conditions of high shear, such as when they pass through a pump. Additionally, some polymeric DRAs can cause undesirable changes in emulsion or fluid quality, or cause foaming problems when used to reduce the drag of multiphase liquids.

Surfactants, such as quaternary ammonium salt cationic surfactants, are known drag reducing agents in aqueous (non-hydrocarbon-miscible) systems and have the advantage over polymeric DRAs in that they do not degrade irreversibly when sheared. In contrast, flow-induced structures in surfactant solutions are reversible. However, the use of a surfactant in reducing the drag of mixed flow fluids such as the mixture of hydrocarbons and water can have the undesired side effect of creating a tight emulsion during flow that must be resolved downstream. Other drag reducing agents have tendencies to form deleterious emulsions, or perpetuate emulsions already formed.

Thus, it would be desirable if a drag reducing agent could be developed which rapidly dissolves in the flowing water-hydrocarbon mixture or emulsion, which could minimize or eliminate the need for special equipment for preparation and incorporation into the water-hydrocarbon mixture or emulsion, and which does not tend to form undesirable emulsions or tend to cause already formed emulsions to persist.

### SUMMARY OF THE INVENTION

An object of the invention is to provide an additive that provides a reduction in pressure drop and/or an increase in flow in water-containing gas and oil multiphase production flowlines and transmission lines.

Other objects of the invention include providing a DRA that can be readily manufactured and which does not require special equipment for placement in a conduit transporting hydrocarbon and water mixtures/emulsions or other fluids.

Another object of the invention is to provide a DRA that exhibits substantially lower emulsion creating or enabling tendencies as compared with similar materials or other types of drag reducers.

In carrying out these and other objects of the invention, there is provided, in one form, a method of reducing drag of a fluid that involves providing a fluid that is a mixture of hydrocarbons and water; a mixture of hydrocarbons, water and gas; a mixture of hydrocarbons, water and solids; a mixture of hydrocarbons, water, gas and solids; a mixture of water, gas, and hydrocarbon solids; or a mixture of water and hydrocarbon solids. An anionic, hydrophilic polymer additive is added to the fluid in an amount effective to reduce the drag thereof.

There is also provided, in another non-limiting form, a reduced-drag fluid that includes a mixed fluid that is a mixture of hydrocarbons and water; a mixture of hydrocarbons, water and gas; a mixture of hydrocarbons, water, gas and solids; a mixture of water, gas, and hydrocarbon solids; or a mixture of water and hydrocarbon solids; and a mixture of hydrocarbons, water and gas together with an anionic, hydrophilic polymer additive in an amount effective to reduce the drag thereof.

### DETAILED DESCRIPTION OF THE INVENTION

The present invention relates to the use of high molecular weight (MW) anionic, hydrophilic polymers such as polyacrylamides for effecting flow improve-ment in multiphase oil and gas production while minimizing the formation and/or persistence of deleterious emulsions. Multiphase oil and gas pipelines (e.g., oil/water, oil/water/gas, oil/water/solids) such as are used for oil or gas production and gathering, and gas gathering and transmission lines (e.g., gas/condensate/water and oil/water/gas/solids), for hydrotransport of oilsand or heavy oil slurries, or evacuation of oily waste sludge from ponds and pits are systems that can benefit from using anionic polymer additive that bears an anionic charge in the polymer backbone. It has been discovered in particular that polyacrylamides that contain anionicity in the polymer backbone enjoy the distinct advantage of exhibiting substantially lower emulsion creating tendency as compared with their cationically or neutrally modified congeners. The specific range of drag reducing polymers compatible with the emulsion forming tendencies of multiphase flow have been identified herein.

Many multiphase oil and gas production systems are limited in their production due to excessive pressure drop in the flowlines. In water-containing multiphase systems, the formation of emulsions upon treatment with a flow modification chemical prevents such flow improvement chemical from being used. Through the use of anionically modified (i.e., partially hydrolyzed) polyacrylamide, effective and beneficial flow modification is realized while minimizing the formation of undesirable emulsions. On the other hand, the use of cationically modified polyacrylamides has been demonstrated to create significant and slowly resolving emulsions. Such emulsions are difficult to resolve on the receiving end and are known to increase the laminar viscosity of multiphase fluids, thus reducing, if not eliminating, the gain from their reduction of the turbulent drag. Lipophilic polymers are not able to reduce the turbulent drag in the aqueous phase, which, in most cases, is controlling.

Often oil and gas production and flowlines contain significant levels of water in the liquid phase. In water-free systems, the use of high MW, lipophilic polymers, such as poly-alpha olefins or alkylaluminates is known.

Lipophilic polymers are those that partition between an aqueous and oleaginous phase, mostly to the latter. Hydrophilic polymers are those that partition between an aqueous and oleaginous phase, mostly to the former. The division in a particular case will depend on the salinity of the water, the aromaticity or other polarity of the oil, and the temperature, among other interrelated factors.

The MW needed to achieve this effect is generally greater than 1 megadalton (MD). The precise limit in a particular case depends on the degree and scale of the “turbulence” to be suppressed, as well as the effective linear density (weight per statistical length or radius of gyration) of the polymer employed. Individual molecular species above this limit have an increasingly powerful effect. Species below this limit have little if any effect. The distribution of MW of a batch of bulk polymer is important only to the extent it influences the number of species above this limit. Thus a batch on average below the limit will work better the broader the distribution; a batch on average above the limit will work better the narrower its distribution. This is generally true of both lipophilic polymers in oil and hydrophilic polymers in water. In another non-limiting embodiment, the MW of the high MW, anionic hydrophilic polymers of this invention are greater than 5 MD and in another non-limiting embodiment, between 5 and 30 MD. Production and handling limitations generally limit the maximum MW to under 100 MD. MWs greater than this may work better but are harder to use effectively.

The use of hydrophilic polymers for improving fluid flow properties in multiphase systems has received relatively little or no attention, and has not achieved commercial status. In efforts to investigate the use of hydrophilic polymers in multiphase systems containing both water and oil, the inventors discovered unexpectedly that the hydrophilicity of the polymer has a significant impact the ability of the polymer to reduce the systemic flow resistance. Specifically, it has been discovered that the reduction in pressure drop in a multiphase, water-and-hydrocarbon flow line is achieved by minimizing turbulence, and thereby resistance to flow, in the aqueous phase. Because this aqueous phase is less viscous than the oil phase, it is believed to contribute less to the laminar resistance but more to the turbulent resistance. In a water-gas-hydrocarbon multiphase flow system, the reduction in pressure drop is achieved by modifying the flow regime of the gas-liquid flow (e.g. from slug to stratified wavy) by changing its interfacial properties (e.g. density, apparent viscosity, surface tension).

In oil-free, single phase, aqueous systems, such as water floods used to induce greater production of oil and gas, there is described in the prior art the use of high MW, hydrophilic polymers for use as drag reducing agents. In fact, cationic, anionic, and nonionic polymers have been used commercially for just such single phase aqueous applications.

Cationic polymers are those that dissociate in water to polymeric cations and individual anions. Examples include polymers of acrylic or methacrylic alkylene esters or amides of trialkyl or alkylaryl ammonium or pyridinium salts; vinyl or allyl trialkyl or alkylaryl, or diallyl dialkyl or alkylaryl ammonium or pyridinium salts; and co-polymers of these with nonionic acrylic or methacrylic esters, amides, or nitrites; or vinyl alcohols, esters, and amides.

Anionic polymers are those that dissociate in water to polymeric anions and individual cations. Examples include polymers of acrylic or methacrylic acids or esters or amides of alkylene or alkylenearyl sulfonic acids or salts thereof; vinyl alkylene or alkylenearyl sulfonic acids or salts thereof, and anionic co-polymers of these with nonionic acrylic esters, amides, or nitrites; or vinyl alcohols, esters, and amides. Within the context of this invention, when the general term “alkyl” or “alkylene” is used, the average number of carbon atoms in these moieties may range from about 1 to about 12, and in an alternative, non-restrictive embodiment, from about 1 to about 4. In one alternative, non-limiting embodiment of the invention, the anionic polymers do not include copolymers containing poly(ethoxy)acrylate groups.

Nonionic polymers are those that do not dissociate into polymeric ions. Examples include polymers of acrylic or methacrylic esters, amides, or nitrites, vinyl alcohols, esters, and amides, and co-polymers of these.

The ionicity or charge density of such polymers is typically expressed in terms of the mole percent (m %) or weight percent (w %) of the polymer comprising the ionic monomer.

There is also described in prior methods the use of polyacrylamide for use as a drag reducing agent in single phase aqueous systems such as in water flood applications in oil and gas production. As mentioned, polyacrylamide has been used commercially for just such single phase aqueous applications. In contrast, the use of polyacrylamides for improving fluid flow properties in multiphase systems, (e.g. water-oil, water-oil-gas) has received relatively little or no attention, and has certainly not achieved a level sufficient for commercial applications of any use. It has been discovered unexpectedly that the ionicity of the hydrophilic polymers has a significant impact on the tendency of water-containing systems to create emulsions. Specifically, it has been discovered that anionic, hydrophilic polymers enjoy the distinct advantage of exhibiting substantially lower emulsion creating tendency than similar polymers containing cationic monomers. Thus, the present invention relates to the use of anionic hydrophilic polymers for effecting flow improvement in multiphase gas/oil production while minimizing the formation and/or persistence of deleterious emulsions. The DRAs of this invention thus do not contribute substantially to any emulsion in the fluid treated.

The present invention additionally relates to methods and compositions for reducing drag and improving flow in turbulent, multiphase water-hydrocarbon systems with little or no substantial change in the bulk fluid viscosity of the multiphase system. Water-hydrocarbon systems include, but are not necessarily limited to, any flowing stream that has at least 0.5% of an immiscible hydrocarbon component in water. Water-hydrocarbon systems include, but are not necessarily limited to, multiphase flow lines (for example oil/water, oil/water/gas, solids hydrocarbon in water slurry) in oil, bitumen, coal, and gas production systems. It will be appreciated that by the term “hydrocarbon”, it is expected that water immiscible oxygenated, sulfurated, halogenated, silanated, or nitrogenated hydrocarbons such as higher alcohols, glycols, amines, acids, amides, ethers, esters, sulfides, thiophenes, chloro- or fluorocarbons, silicones and the like may be included within the definition. It will also be appreciated that by the term “water” it is expected that hydrocarbon immiscible oxygenated, sulfurated, or nitrogenated hydrocarbons such as lower alcohols, glycols, amines, acids, amides, and the like may be included within the definition. The term “water-hydrocarbon fluid” also means any fluid that contains water and hydrocarbon, as defined herein to also include water-like and hydrocarbon-like oxygenates, nitrogenates, etc. Thus, multiphase water-hydrocarbon-containing systems (e.g. oil/water, oil/water/gas, solid hydrocarbon/water slurries), such as oil, bitumen, coal, and gas production flow lines are primary applications for this technology. Conventional polymer-based drag reducers for hydrocarbons (e.g. poly(alpha-olefins)) are generally not suitable for these applications because of their system fluid incompatibility.

Multiphase oil pipelines (e.g., oil/water, oil/water/gas), slurry flow lines (e.g., solid hydrocarbon/water) and gas gathering and transmission lines (e.g., gas/condensate/water, gas/oil/water) are systems that can benefit from using suitable polymers that bear an anionic charge in the polymer backbone. In one nonlimiting embodiment of the invention, suitable polymers include, but are not limited to, anionic polymers of acrylic or methacrylic alkylene esters or amides of trialkyl or alkylaryl ammonium salts; vinyl or allyl trialkyl or alkylaryl, or diallyl dialkyl or alkylaryl ammonium salts; and co-polymers of these with nonionic acrylic or methacrylic esters, amides, or nitrites; or vinyl alcohols, esters, and amides; and combinations thereof. Methods of producing anionic, hydrophilic polymers are well known and include, but are not necessarily limited to, incorporating into the polymer, at its inception or later, at least some monomers which dissociate at the system pH, at least to some extent, to an incorporated monomeric anion and an unincorporated, labile, dissolved cation. The anionic monomers may be included in the mix of monomers being polymerized, or they may be created by reaction with originally non-ionic or even cationic monomers post-polymerization. For example, the anionic acrylic monomer sodium acrylate can be homopolymerized, or mixed with the nonionic acrylic monomer acrylamide and copolymerized, randomly or in blocks, via induction with and propagation of free radicals in aqueous or saline solution; or the acrylamide alone can be homopolymerized in said manner and then reacted with sodium hydroxide to create a homopolymer of sodium acrylate or copolymer of sodium acrylate and acrylamide. Typical free radical polymerization initiators include thermally homolytic peroxides and azo compounds and redox pairs. The polymerization may be carried out in free liquid or in droplets dispersed in oil. Post-polymerization, the aqueous solvent can be left in to form a viscous dilute solution, dispersion in brine, or emulsion in oil; or removed to form a powder, or a dispersion in oil.

The needed hydrophilicity may be present in the monomer prior to polymerization, as in acrylamide, or may be created after polymerization, as when lipophilic vinyl acetate is polymerized (or copolymerized), then reacted with sodium hydroxide to hydrophilic (but nonionic) poly(vinyl alcohol) and an acetate anion.

Even the needed high MW may be the result of an original polymerization, or of a secondary crosslinking, via mutually reactive end or pendant groups or intermediates, of lower MW polymers or oligomers.

In one non-limiting embodiment of the invention, the molecular weight of the polymer ranges from about 1 MD to about 30 MD average molecular weight. In another, alternate embodiment of the invention, the molecular weight of the polymer ranges from about 5 MD to about 20 MD.

Suitable solvents for use with the high MW anionic, hydrophilic polymer of this invention include aqueous solvents and polar organic solvents. More particularly, suitable solvents include, but are not necessarily limited to, water, lower alcohols, glycols, amines, acids and mixtures thereof. However, in another non-limiting embodiment of the invention, the anionic, hydrophilic polymer additive is delivered as a product in the absence of a lower alkyl alcohol or glycol, or alternatively, a subsequently added lower alkyl alcohol or glycol. Lower alkyl alcohols or glycols are generally defined by their miscibility as described previously, and an alternate, nonlimiting embodiment are defined herein as having 1-8 carbon atoms. In another non-limiting embodiment, these solvent alcohols and glycols are different from any that may be present in the system or the fluid treated. The proportion of anionic, hydrophilic polymer in the solvent may range from about 1 to less than 100 wt %, in an alternative, non-restrictive embodiment from about 15 to about 45 wt %.

Many oil and gas production systems (e.g. those that transport and produce gas and oil from deep water reservoirs in the Gulf of Mexico and elsewhere) are limited in their production due to pressure drop in the flowlines under “turbulent” or intermittent flow regime. The drag reducing methods of the invention comprise applying additives to the system by continuous treatments at high enough concentrations to produce the desired reduction in drag and/or increase in flow for the same amount of motive energy. The compositions containing the additive are used effectively by maintaining drag reduction effectiveness over an extended period of time.

One non-limiting embodiment of practicing this invention is through continuous injection of the anionically modified polyacrylamide product into the flowlines or transmission lines in order to achieve increased production and/or reduction in pressure drop through the treated system. In the continuous treatment, the product is used at high enough concentration to produce the desired flow modification without causing emulsion, foaming or other oil/water/gas quality problems. The reduction in pressure drop in a multiphase flowline is achieved by modifying the flow regime in the water/hydrocarbon system. It will be appreciated that it is difficult to specify in advance what the desired or necessary proportions are in any given application. An effective use concentration is dependent upon many interrelated variables in the system being treated including, but not necessarily limited to, temperature, water cut, fluid velocity, the particular additive used, etc. Nevertheless, in one non-limiting embodiment, a typical effective use concentration range is about 1 to about 2000 parts of active, high MW, anionic, hydrophilic polymer per million parts water. Another non-restrictive use concentration range may be from about 10 to about 500 ppm polymer to water, and in an alternate, non-limiting embodiment from about 10 to about 200 ppm polymer additive. In one non-limiting embodiment of the invention, the drag reducing additives herein are added in the absence of any other polymeric drag reducing additive not within the definitions of this invention. Other alternative manners of practicing this invention include through continuous injection of the additive or product via umbilicals or capillaries into the fluid flowlines.

In another non-limiting embodiment of the invention, the drag reducing additives are employed in the absence of any other drag reducing additive, i.e. one that does not fall within the definitions of this invention. On the other hand, there may be situations or environments where it is advantageous to employ other drag reducing additives together with those of this invention in effective mixtures, such mixtures being within the bounds of this invention. For instance, such mixtures may be helpful in spreading the drag reduction effects of the additives further over time and/or distance. In another non-limiting embodiment of the invention, the additive or additive product has the absence or minimal presence (less than 15% of the polymer) of a surfactant. A minimal, non-interfering amount of surfactant may be optionally used to create and stabilize the emulsion polymer (less than 15% of the polymer).

Other suitable additives that may also be included with the anionic polymers of the invention include amine-based and non-amine based corrosion inhibitors, such as imidazolines, amides, fatty acid-based inhibitors, phosphate esters etc.; non-amine based biocides, such as acrolein; non-amine based gas hydrate inhibitors, such as nonionic antiagglomerants and kinetic inhibitors; scale inhibitors, and the like

To further illustrate the invention, the inventive method will be additionally described by way of the following non-limiting Examples, which are intended only to further show specific embodiments of the invention.

Polymers Evaluated

Five hydrophilic polymers were evaluated for both emulsion forming tendency and drag reduction potential. These included simple polyacrylamide and both cationic and anionic acrylate/acrylamide copolymers, with charge densities ranging from +70 m % (cationic) to −30 m % (anionic), polymerized inside a self-inverting water-in-oil (invert) emulsion at about 35% active to a MW of 5-20 MD.

TABLE I
High MW Hydrophilic Polymers Evaluated

| Ex. | Polymer | Type | lonicity | MW |
|---|---|---|---|---|
| 1 | C-Hi | AETAC:AM | +70 m % | 5 MD |
| 2 | C-Lo | AETAC:AM | +30 m % | 10 MD |
| 3 | N | AM | 0 | 20 MD |
| 4 | A-Lo | NaA:AM | −15 m % | 20 MD |
| 5 | A-Hi | NaA:AM | −30 m % | 20 MD |

Where
AETAC is acroylethyltrimethylammonium chloride,
AM is acrylamide, and
NaA is sodium acrylate, where
MW is approximate weight average molecular weight.
   Emulsion Forming Tendency

The emulsion forming tendency for these polymers was determined as follows: A 150 mL bottle was charged with 50 mL of a 1% NaCl brine solution and 50 mL of a crude oilfield hydrocarbon. The hydrophilic polymer emulsion was added to the bottles at 200 ppm as product to total fluids. The fluids were then mixed well using a high speed (˜10 k rpm) mixer for 10 seconds. The rate of visual phase separation, if any, was measured. The results of this test are presented in Table II.

These five samples were allowed to stand undisturbed for 30 minutes, then, to measure the trend with respect to continued agitation, they were subjected to another 10 seconds of high speed mixing. The rate of separation was again evaluated, as before. The results of this test are also presented in Table II.

TABLE II
Time to Complete Separation

| Ex. | Polymer | Initial Mixing | Second Mixing | Trend w/ Agitation |
|---|---|---|---|---|
| 1 | C-Hi | >20 minutes | >30 minutes | Increasing |
| 2 | C-Lo | 3 minutes | 6.0 minutes | Increasing |
| 3 | N | 2.5 minutes | 0.8 minutes | Decreasing |
| 4 | A-Lo | 1.0 minute | 0.6 minutes | Decreasing |
| 5 | A-Hi | 2.5 minutes | 1.7 minutes | Decreasing |
| 6 | Blank | 0.2 minutes | 0.2 minutes | No change |

Of particular importance in scaling up the results of this test to real, continuously flowing systems is the trend with respect to further agitation. The relative effects of both stabilizing and destabilizing forces are accelerated by agitation. If the trend is one of increasingly severe emulsification with continued agitation, the problem will grow worse as it flows down the line. If the trend is one of decreasing emulsification with continued agitation, the problem will diminish or disappear.
Drag Reduction

Drag reduction potential was evaluated with a torque testing apparatus. In this apparatus, a 100 mL capacity double walled cylindrical glass cylinder is secured in a temperature controlled water bath. A concentric aluminum cylinder is placed inside. The 2 mm thick gap between the cylinders is filled with the multiphase, non-emusifying fluid. The inner cylinder is spun at a constant rate sufficient to impart a turbulent flow regime. Resistance to the applied rotational force is measured with a torque meter attached to the spinning cylinder. The signal is digitized and electronically recorded. Drag reduction aid (DRA) candidates are added to the fluid as it is being sheared in the gap, using a micro-syringe. Percent drag reduction (% DR) is calculated using the formula:

$$DR \% = 100 \times \frac{( {Torque}_{Sol} - {Torque}_{DRA} )}{( {Torque}_{Sol} - {Torque}_{Air} )}$$

where Torque_{Air}, Torque_{Sol} and Torque_{DRA} are the torque values in air, solution without DRA and solution with DRA, respectively.

The induction time needed for the polymer particles in the invert emulsion product to invert, or hydrate and allow the individual polymer molecules to extend themselves into the aqueous phase, was determined from the DR response with respect to time. The % DR at the end of this induction time and 30 minutes later were used to quantify the trends with respect to time.

The drag reduction results for the five hydrophilic polymers are shown in Table III. The tests were carried out in a 50:50 mixture of synthetic seawater and cyclopentane at 22 C with 25 ppm DRA product to total fluids added.

TABLE III
Multiphase Drag Reduction

| Ex. | Polymer | Induction Time (s) | Initial % DR | 30 min. % DR |
|---|---|---|---|---|
| 1 | C-Hi | 60 | 9 | 13 |
| 2 | C-Lo | 200 | 14 | 14 |
| 3 | N | 430 | 2 | 4 |
| 4 | A-Lo | 30 | 13 | 13 |
| 5 | A-Hi | 80 | 14 | 15 |

Both the cationic and anionic polymers were equally effective eventually at reducing drag, but the cationic products were much slower at achieving the maximum effect, either due to a lengthy induction or a slow post-induction ramp. It is believed that the same deleterious association with oil (dispersed oil naturally carries an anion charge) that induces emulsification (at least with crude oil at higher dosages) retards the hydration of the polymer in multiphase fluids generally, to the detriment of its initial drag reduction effect. This delay can be a significant fraction of the total time spent in the production or transport line.

Many modifications may be made in the composition and implementation of this invention without departing from the spirit and scope thereof that are defined only in the appended claims. For example, the exact drag reducing additive(s) and mixture having its friction properties modified may be different from those used explicitly used here. Additionally, high MW, anionic, hydrophilic polymers other than those specifically mentioned may find utility in the methods of this invention. Various combinations of anionic, hydrophilic polymers, solvents or non-solvent carriers thereof, alone or together with other materials besides those explicitly mentioned herein, are also expected to find use as drag reducing agents.

1. A method of reducing drag of a fluid comprising:
providing the fluid selected from the group consisting of mixtures of hydrocarbons and water; mixtures of hydrocarbons, water and gas; mixtures of hydrocarbons, water and solids; mixtures of hydrocarbons, water, gas and solids; mixtures of water, gas, and hydrocarbon solids; and mixtures of water and hydrocarbon solids; and
adding an anionic, hydrophilic polymer additive to the fluid in an amount effective to reduce the drag thereof.

2. The method of claim 1 where the anionic, hydrophilic polymer additive is selected from the group consisting of anionic polymers of acrylic or methacrylic acids or esters or amides of alkylene or alkylenearyl sulfonic acids or salts thereof; anionic polymers of vinyl alkylene or alkylenearyl sulfonic acids or salts thereof; and anionic co-polymers of these monomers with nonionic acrylic or methacrylic esters, amides, or nitriles; or vinyl alcohols, esters, and amides; and combinations thereof.

3. The method of claim 1 where the anionic, hydrophilic polymer additive has a molecular weight ranging greater than 1 megadalton.

4. The method of claim 1 where the anionic, hydrophilic polymer additive is a copolymer of acrylamide and acrylic acid or salts thereof.

5. The method of claim 1 where in adding the anionic, hydrophilic polymer additive, the amount of anionic polymer additive based on the total amount of water ranges from about 1 to 2000 ppm.

6. The method of claim 1 where the anionic, hydrophilic polymer additive is delivered as a product further comprising a solvent selected from the group consisting of an aqueous solvent and a non-aqueous solvent.

7. The method of claim 1 where the anionic, hydrophilic polymer additive is delivered as a product further comprising a non-solvent carrier oil selected from the group consisting of liquid hydrocarbons.

8. The method of claim 1 where the anionic, hydrophilic polymer additive has a reduced tendency to form emulsion as compared with an otherwise identical polymer having no anionic groups.

9. The method of claim 1 where the anionic, hydrophilic polymer additive more rapidly achieves maximum drag reducing effect as compared with an otherwise identical polymer having no anionic groups.

10. A method of reducing drag of a fluid comprising:
providing the fluid selected from the group consisting of mixtures of hydrocarbons and water; mixtures of hydrocarbons, water and gas; mixtures of hydrocarbons, water and solids; mixtures of hydrocarbons, water, gas and solids; and mixtures of water, gas, hydrocarbon solids; and mixtures of water and hydrocarbon solids; and
adding an anionic, hydrophilic polymer additive to the fluid in an amount effective to reduce the drag thereof, where the anionic, hydrophilic polymer additive has a molecular weight ranging greater than 1 megadalton; and is selected from the group consisting of anionic polymers of acrylic or methacrylic acids or esters or amides of alkylene or alkylenearyl sulfonic acids or salts thereof; anionic polymers of vinyl alkylene or alkylenearyl sulfonic acids or salts thereof; and anionic co-polymers of these monomers with nonionic acrylic or methacrylic esters, amides, or nitriles; or vinyl alcohols, esters, and amides; and combinations thereof.

11. The method of claim 10 where the anionic, hydrophilic polymer additive is a copolymer of acrylamide and acrylic acid or salts thereof.

12. The method of claim 10 where in adding the anionic, hydrophilic polymer additive, the amount of anionic polymer additive based on the total amount of water ranges from about 1 to 2000 ppm.

13. The method of claim 10 where the anionic, hydrophilic polymer additive is delivered as a product further comprising a solvent selected from the group consisting of an aqueous solvent and a non-aqueous solvent.

14. The method of claim 10 where the anionic, hydrophilic polymer additive is delivered as a product further comprising a non-solvent carrier oil selected from the group consisting of liquid hydrocarbons.

15. The method of claim 10 where the anionic, hydrophilic polymer additive has a reduced tendency to form emulsion as compared with an otherwise identical polymer having no anionic groups.

16. The method of claim 10 where the anionic, hydrophilic polymer additive more rapidly achieves maximum drag reducing effect as compared with an otherwise identical polymer having no anionic groups.

17. A reduced-drag fluid comprising:
a mixed fluid selected from the group consisting mixtures of hydrocarbons and water; mixtures of hydrocarbons, water and gas; mixtures of hydrocarbons, water and solids; mixtures of hydrocarbons, water, gas and solids; mixtures of water, gas, and hydrocarbon solids; and mixtures of water and hydrocarbon solids; and
an anionic, hydrophilic polymer additive to the fluid in an amount effective to reduce the drag thereof.

18. The reduced-drag fluid of claim 17 where the anionic, hydrophilic polymer additive is selected from the group consisting of anionic polymers of acrylic or methacrylic acids or esters or amides of alkylene or alkylenearyl sulfonic acids or salts thereof; anionic polymers of vinyl alkylene or alkylenearyl sulfonic acids or salts thereof; and anionic co-polymers of these monomers with nonionic acrylic or methacrylic esters, amides, or nitrites; or vinyl alcohols, esters, and amides; and combinations thereof.

19. The reduced-drag fluid of claim 17 where the anionic, hydrophilic polymer additive has a molecular weight ranging greater than 1 megadalton.

20. The reduced-drag fluid of claim 17 where the anionic, hydrophilic polymer additive is a copolymer of acrylamide and acrylic acid or salts thereof.

21. The reduced-drag fluid of claim 17 where the amount of anionic, hydrophilic polymer additive based on the total amount of water ranges from about 1 to 2000 ppm.

22. The reduced-drag fluid of claim 17 where the anionic, hydrophilic polymer additive further comprises a solvent selected from the group consisting of an aqueous solvent and non-aqueous solvent.

23. The method of claim 17 where the anionic, hydrophilic polymer additive is delivered as a product further comprising a non-solvent carrier oil selected from the group consisting of liquid hydrocarbons.

24. The reduced-drag fluid of claim 17 where the anionic, hydrophilic polymer additive has a reduced tendency to form emulsion in the mixed fluid as compared with an otherwise identical polymer having no anionic groups.

25. The reduced-drag fluid of claim 17 where the anionic, hydrophilic polymer additive more rapidly achieves maximum drag reducing effect as compared with an otherwise identical polymer having no anionic groups.

26. A reduced-drag fluid comprising:
a mixed fluid selected from the group consisting mixtures of hydrocarbons and water; mixtures of hydrocarbons, water and gas; mixtures of hydrocarbons, water and solids; mixtures of hydrocarbons, water, gas and solids; mixtures of water, gas, and hydrocarbon solids; and mixtures of water and hydrocarbon solids; and
an anionic, hydrophilic polymer additive to the fluid in an amount effective to reduce the drag thereof where the anionic, hydrophilic polymer additive has a molecular weight ranging greater than 1 megadalton, and is selected from the group consisting of anionic polymers of acrylic or methacrylic acids or esters or amides of alkylene or alkylenearyl sulfonic acids or salts thereof; anionic polymers of vinyl alkylene or alkylenearyl sulfonic acids or salts thereof; and anionic copolymers of these monomers with nonionic acrylic or methacrylic esters, amides, or nitrites; or vinyl alcohols, esters, and amides; and combinations thereof.

27. The reduced-drag fluid of claim 26 where the anionic, hydrophilic polymer additive is a copolymer of acrylamide and acrylic acid or salts thereof.

28. The reduced-drag fluid of claim 26 where the amount of anionic, hydrophilic polymer additive based on the total amount of water ranges from about 1 to 2000 ppm.

29. The reduced-drag fluid of claim 26 where the anionic, hydrophilic polymer additive further comprises a solvent selected from the group consisting of an aqueous solvent and non-aqueous solvent.

30. The reduced-drag fluid of claim 26 where the anionic, hydrophilic polymer additive is delivered as a product further comprising a non-solvent carrier oil selected from the group consisting of liquid hydrocarbons.

31. The reduced-drag fluid of claim 26 where the anionic, hydrophilic polymer additive has a reduced tendency to form emulsion in the mixed fluid as compared with an otherwise identical polymer having no anionic groups.

32. The reduced-drag fluid of claim 26 where the anionic, hydrophilic polymer additive more rapidly achieves maximum drag reducing effect as compared with an otherwise identical polymer having no anionic groups.
